(19) United States
(12) Patent Application Publication
(10) Pub. No.: US 2026/0277231 A1
(43) Pub. Date: Sep. 17, 2026

(54) Path Planning for Unmanned Aerial Vehicles

(71) Applicant: Florida Power & Light Company, Juno Beach, FL (US)

(72) Inventors: Christopher Heath McLEMORE, Jupiter, FL (US); William M. DORR, Jupiter, FL (US); Matthew E. HARVEY, Palm City, FL (US); Kyle A. BUSH, Palm Beach Gardens, FL (US)

(21) Appl. No.: 19/016,788

(22) Filed: Jan. 10, 2025

(51) Int. Cl. G05D 1/644; G05D 1/646; G05D 105/80; G05D 109/20; G05D 111/10

(52) U.S. Cl. CPC G05D 1/6445; G05D 1/646; G05D 2105/89; G05D 2109/20; G05D 2111/10

(57) ABSTRACT

A flight system causing a processor to execute operations is provided. The operations include causing an unmanned aerial vehicle (UAV) to travel a predetermined flight path to a region of interest including an estimated location of electrical infrastructure. The operations include receiving initial sensor data from the UAV of the region of interest. The operations include determining an actual location of the electrical infrastructure. The operations include identifying an electrical infrastructure type of the electrical infrastructure. The operations include identifying a set of desired images based on the actual location, the electrical infrastructure type, and image parameters that define an image framing of the electrical infrastructure. The operations include generating an inspection flight path toward the actual location. The operations include causing the UAV to obtain a set of captured images of the electrical infrastructure corresponding to the set of desired images, each captured image having the image framing.

### TECHNICAL FIELD

This description relates to a flight system for path planning using unmanned aerial vehicles (UAVs) that inspect electrical infrastructure.

### BACKGROUND

The electrical infrastructure of power grid systems is routinely inspected to identify maintenance needs and potential hazards. However, the growing scale of the power grid systems, makes inspecting the electrical infrastructure increasingly arduous. Typically, human inspectors perform ground-based inspections of the electrical infrastructure (e.g., towers, utility poles, utility corridors, high voltage facilities, etc.), which require significant human resources, time, and transportation to traverse the power grid system. Furthermore, it is difficult for a ground-based inspector to visualize high voltage components at the top of the lines, towers, and utility poles. Manned aerial inspections, using helicopters and light aircraft, provide visibility of the top surfaces of the lines, towers, and utility poles but are more dangerous since inspectors are flying around high voltage devices. For safety reasons, manned aircraft fly roughly the same distance away from the electrical infrastructure as the ground inspections, so the manned aerial inspections may be obstructed by vegetation, buildings etc. Unmanned aerial inspections are able to visualize more angles of the electrical infrastructure and are safer for inspectors but rely on manual control or pre-programmed flight patterns that do not account for framing issues caused by real world changes, such as obstructions, shifting, etc.

### SUMMARY

In one example, a non-transitory machine-readable medium having machine-readable instructions for a flight system causing a processor to execute operations. The operations include causing an unmanned aerial vehicle (UAV) to travel a predetermined flight path to a region of interest including an estimated location of electrical infrastructure. The operations also include receiving initial sensor data from the UAV of the region of interest. The operations further include determining an actual location of the electrical infrastructure based on the initial sensor data. The operations yet further include identifying an electrical infrastructure type of the electrical infrastructure based on the initial sensor data. The operations include identifying a set of desired images based on the actual location, the electrical infrastructure type, and image parameters that define an image framing of the electrical infrastructure. The operations also include generating an inspection flight path toward the actual location of the electrical infrastructure to capture the set of desired images. The operations further include causing the UAV to obtain a set of captured images of the electrical infrastructure corresponding to the set of desired images, each captured image of the set of captured images having the image framing of the electrical infrastructure.

Another example relates to a flight inspection system that includes a memory for storing machine-readable instructions and a processor core. The processor core accesses the machine-readable instructions and executes the machine-readable instructions as operations. The operations include causing an unmanned aerial vehicle (UAV) to travel a predetermined flight path to a region of interest including an estimated location of electrical infrastructure. The operations also include receiving initial sensor data from the UAV of the region of interest. The operations further include determining an actual location of the electrical infrastructure based on the initial sensor data. The operations yet further include identifying an electrical infrastructure type of the electrical infrastructure based on the initial sensor data. The operations include identifying a set of desired images based on the actual location, the electrical infrastructure type, and image parameters that define an image framing of the electrical infrastructure. The operations also include generating an inspection flight path toward the actual location of the electrical infrastructure to capture the set of desired images. The operations further include causing the UAV to obtain a set of captured images of the electrical infrastructure corresponding to the set of desired images, captured images of the set of captured images having the image framing of the electrical infrastructure.

In yet another example, a path planning method is provided. The method includes causing an unmanned aerial vehicle (UAV) to travel a predetermined flight path to a region of interest including an estimated location of electrical infrastructure based on location data of the electrical infrastructure. The method also includes receiving initial sensor data from the UAV of the region of interest. The method further includes determining an actual location of the electrical infrastructure based on the initial sensor data. The method yet further includes identifying an electrical infrastructure type of the electrical infrastructure based on the initial sensor data. The method includes generating a set of desired images based on the actual location, the electrical infrastructure type, and image parameters that define an image framing of the electrical infrastructure. The method also includes generating an inspection flight path toward the actual location of the electrical infrastructure to capture the set of desired images. Generating the inspection flight path includes verifying the estimated location is the actual location or calculating an adjusted distance between the estimated location and the actual location. The method further includes updating the location data in response to the adjusted distance being calculated.

### BRIEF DESCRIPTION OF THE DRAWINGS

FIG. 1 illustrates a diagram of an example physical environment for an inspection application.

FIG. 2 illustrates an example of an operating environment for an inspection application.

FIG. 3 illustrates a diagram of an example predetermined flight path.

FIG. 4 illustrates a diagram of a region of interest at the estimated location of FIG. 3.

FIG. 5 illustrates a diagram of an example of an unmanned aerial vehicle (UAV) for inspecting electrical infrastructure.

FIG. 6 illustrates an example of image framing based on a field of view of a desired image.

FIG. 7 illustrates a flowchart of an example method for path planning for an unmanned aerial vehicle.

### DETAILED DESCRIPTION

The present disclosure relates to an inspection system for path planning using unmanned aerial vehicles (UAVs) that inspect electrical infrastructure that delivers, senses, monitors, facilitates, or transmits electrical current. UAVs are suited for inspection because UAVs can be brought closer to the components of the electrical infrastructure, making defects easier to detect. However, the images captured by the UAVs require significant backend image processing to correct the framing of the electrical infrastructure. The framing alters the composition of images of the components of the electrical infrastructure by determining what to include in the image and what to leave out. For example, the conventional UAV systems do not compensate for deviations in the locations of electrical infrastructure, improper angles, or obstructions in images when imaging. Accordingly, the images of traditional UAVs have to be manually modified to correct these framing issues.

As an example, a UAV is deployed to an estimated location that is predicted to be the physical location of the electrical infrastructure. The UAV captures initial sensor data to verify the location of the electrical infrastructure. The inspection application analyzes the initial sensor data of a region of interest that includes the estimated location to determine the actual location of the electrical infrastructure. Based on a type of the electrical infrastructure, a set of desired images is generated. The set of desired images defines the images that constitute an inspection of the electrical infrastructure. In particular, the desired images of the set of desired images each include the correct framing of the electrical infrastructure based on a number of image parameters.

In response to determining the actual location and generating the set of desired images of the electrical infrastructure, the inspection application calculates an inspection flight path for the UAV to obtain captured images corresponding to the set of desired images. The captured images depict a current status of the electrical infrastructure and reveal up to date changes in the operation of the electrical infrastructure and its components. Furthermore, because the captured images are captured at the actual location of the electrical infrastructure and have the image parameters of the desired images, the captured images are framed correctly. Accordingly, back-end image processing is not necessary, thereby saving time and resources that would be otherwise spent correcting the captured images.

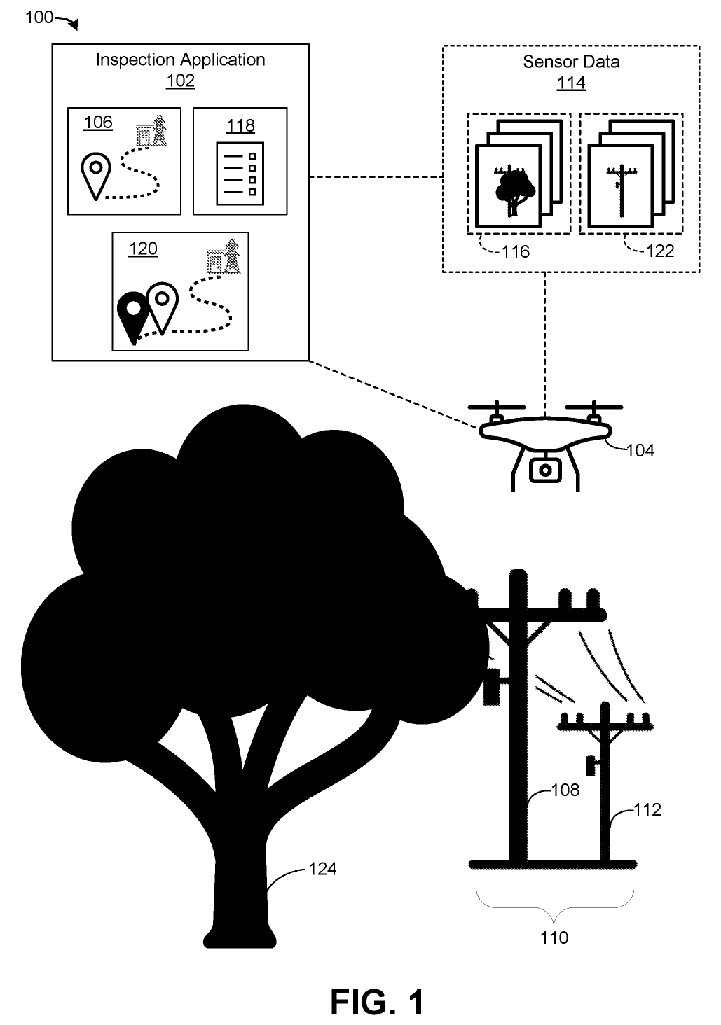

FIG. 1 illustrates a diagram of an example physical environment 100 for a flight inspection system. An inspection application 102 is employed to deploy a number of UAVs including the UAV 104. The UAV 104 is an aircraft without a human pilot and may include a remotely piloted aerial vehicle (RPAV), remotely piloted aircraft system (RPAS), or unmanned aircraft system (UAS) that can function, at least partially, autonomously. Specifically, the UAV 104 is piloted remotely through software-controlled flight plans that can be onboard or remotely accessed. For example, the inspection application 102 calculates a number of predetermined flight paths 106 to an estimated location of electrical infrastructure 108.

The electrical infrastructure 108 delivers, senses, monitors, and/or transmits electrical current and, for example, includes an anchor portal, conductor marking light, digital protective relay, electrical substation, high frequency line trap, hybrid switchgear module, interconnector, motor control center, overhead line, overhead line crossing, power distribution center, power plant, traction current pylon, transformer, or utility pole, among others. In the example of FIG. 1, the electrical infrastructure 108 is a utility pole that is a part of a power distribution system 110 that includes the electrical infrastructure 108 for power transmission. The power distribution system 110 can includes additional electrical infrastructure, such as another utility pole 112 connected the electrical infrastructure 108 by overhead lines.

The inspection application 102 causes the UAV 104 to travel a predetermined flight path of the number of predetermined flight paths 106 to the region of interest including the estimated location. The UAV 104 is deployed from an origin, such as a substation, to travel to the region of interest. The region of interest includes the estimated location of the electrical infrastructure 108. The region of interest is estimated based on historical sensor data, previous flight plan data, third-party location data, such as Geographic Information System (GIS) data, etc. The region of interest is a threshold area including and around the estimated location of the electrical infrastructure 108. The region of interest may be calculated as a threshold distance from the electrical infrastructure 108 and/or be based on previous flight plan data of the UAV 104.

The inspection application 102 is configured to receive sensor data 114 from the UAV 104. For example, the inspection application 102 receives initial sensor data 116, such as initial images of the region of interest from the UAV 104. The inspection application 102 determines the actual location of the electrical infrastructure 108 based on the initial sensor data 116 from the UAV 104 at the region of interest. For example, the inspection application 102 analyzes the region of interest imaged in the initial sensor data 116 to determine the actual location of the electrical infrastructure 108 based on the estimated location of the electrical infrastructure 108. If the physical location of the electrical infrastructure corresponds to the estimated location, then the estimated location is verified as the actual location. If the physical location has deviated from the estimated location, then the actual location is the estimated location adjusted to the physical location.

The inspection application 102 also analyzes the initial sensor data 116 to identify specific components of the electrical infrastructure 108. The inspection application 102 identifies a type of electrical infrastructure based on features of the electrical infrastructure 108. Alternatively, the inspection application 102 receives data identifying the type of electrical infrastructure. For example, the inspection application 102 determines the type of electrical infrastructure to be a utility pole based on a crossbar type. In response to the type of electrical infrastructure being identified, the inspection application 102 identifies a number of components associated with the electrical infrastructure 108. Continuing the example from above, if the electrical infrastructure 108 is a utility pole based on a feature, such as the crossbar type, then a number of components (e.g., insulator, transformer, switches, lightening arrestor, etc.) of the electrical infrastructure 108 are identified.

The inspection application 102 generates a set of desired images 118 having a number of desired images of the number of components of the electrical infrastructure 108. The set of desired images 118 includes an image of at least one component of the electrical infrastructure 108 based on image parameters. The image parameters are based on different angles of the electrical infrastructure 108. For example, quadrant angles have different image parameters than side angles or nadir angles. As one example, the image parameters include a height from the middle of the electrical infrastructure 108, a pitch angle of a UAV sensor of the UAV 104 relative to the electrical infrastructure 108, distance from the electrical infrastructure 108, framing of the electrical infrastructure 108 and/or components, etc.

In response to determining the actual location of the electrical infrastructure 108 and the set of desired images 118, the inspection application 102 generates an inspection flight path 120 for the UAV 104 to obtain the sensor data 114 as captured images 122. While the sensor data 114, including the initial sensor data 116 and the captured images 122, is described as images, the sensor data 114 includes any type of sensor data for identifying and inspecting the electrical infrastructure. For example, the sensor data 114 may include radiation signatures detected at the estimated location and the actual location.

The captured images 122 each include the framing of the electrical infrastructure 108 defined in the set of desired images 118. For example, suppose the electrical infrastructure 108 is adjacent an obstruction 124 in the region of interest. The obstruction 124 may include vegetation such as trees, shrubs, herbs, climbing, coiling, and trailing perennial vines, among other types of plants. The obstruction 124 may also include structures such as buildings, bridges, towers, and tunnels or natural formations like mountains, caves, etc. The initial sensor data 116 includes the obstruction 124 which obscures the electrical infrastructure 108. Accordingly, the initial sensor data 116 is unsatisfactory for inspection because the electrical infrastructure 108 is not fully or adequately visualized. The inspection flight path 120 is calculated to put the UAV 104 in position to provide the framing defined by the set of desired images 118. For example, the inspection flight path 120 causes the UAV to navigate around the obstruction 124, so that the captured images 122 do not include the obstruction 124. Thus, the inspection application 102 causes the UAV 104 to adapt in real-time to changes in the location the electrical infrastructure 108 as well as changes in the physical environment, such as encroachment, obstruction 124, etc. Thus, despite the dynamic nature of the physical environment, the inspection application 102 causes the UAV 104 to capture images of the electrical infrastructure 108 that are satisfactory for inspection without requiring human intervention or back-end image processing that attempts to correct unsatisfactory sensor data.

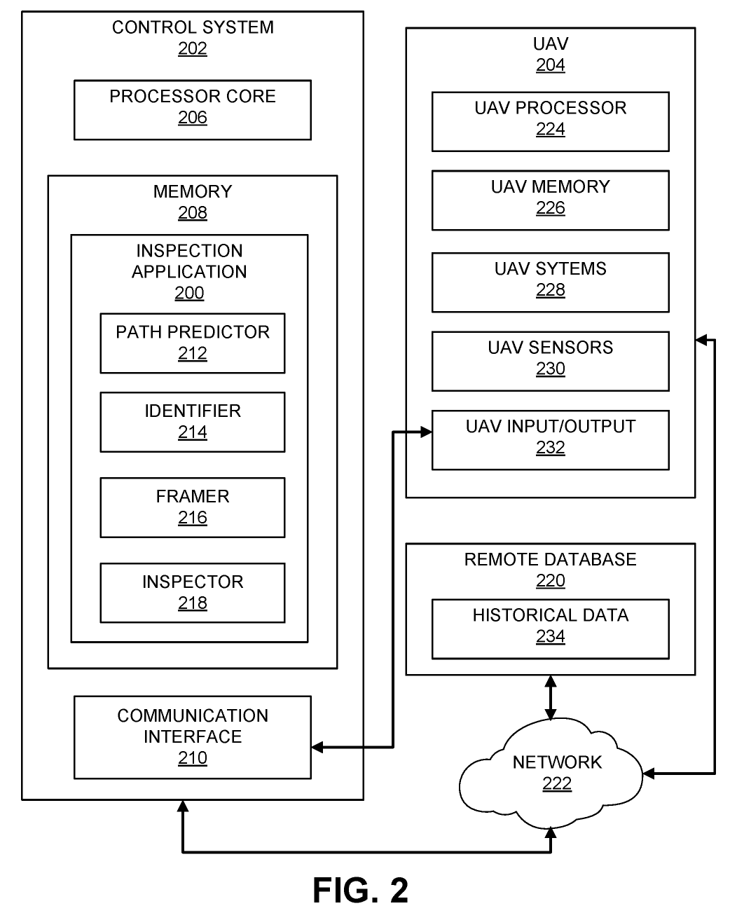

FIG. 2 illustrates an example of an operating environment for an inspection application 200 (e.g., the inspection application 102 of FIG. 1). The inspection application 200 represents application software executing on a computing platform of the operating environment having a control system 202 for inspecting electrical infrastructure (e.g., the electrical infrastructure 108 of FIG. 1) in a region of interest with a UAV 204 (e.g., the UAV 104 of FIG. 1).

The control system 202 includes a processor core 206, a memory 208, and a communication interface 210, which are operably connected for computer communication. The processor core 206 processes signals and performs general computing to execute instructions stored in the memory 208. The instructions cause the processor core 206 to execute operations. The processor core 206 can be a variety of various processors including multiple single and multicore processors, co-processors, and other multiple single and multicore processor and co-processor architectures.

The memory 208 may store an operating system that controls or allocates resources of the inspection application 200. The memory 208 represents a non-transitory machine-readable medium (or other medium), such as RAM, a solid state drive, a hard disk drive or a combination thereof. The inspection application 200 includes modules including a path predictor 212, an identifier 214, a framer 216, and an inspector 218 and stores machine-readable instructions associated with the modules. The inspection application 200 could be representative of a single instance of hardware or multiple instances of hardware with applications executing across the multiple of instances (i.e., distributed) of hardware (e.g., computers, routers, memory, processors, or a combination thereof). Alternatively, the inspection application 200 could be implemented on a single dedicated server. In various examples, the inspection application 200 can include more or fewer of the modules.

The communication interface 210 provides software and hardware to facilitate data input and output between the inspection application 200 and data sources, such as the UAV 204 and remote database 220 via a network 222. The network 222 is, for example, a data network, the Internet, a wide area network (WAN) or a local area (LAN) network. The network 222 serves as a communication medium to various remote devices (e.g., databases, web servers, remote servers, application servers, intermediary servers, client machines, other portable devices).

The UAV 204 includes a UAV processor 224 and a UAV memory 226. The UAV processor 224 processes signals and executes instructions stored in the UAV memory 226. The instructions are received from the inspection application 200. The UAV processor 224 can be a variety of various processors including multiple single and multicore processors, co-processors, and other multiple single and multicore processor and co-processor architectures. The UAV memory 226 represents a non-transitory machine-readable medium (or other medium), such as RAM, a solid state drive, a hard disk drive or a combination thereof.

The UAV 204 also includes UAV systems 228 and UAV sensors 230. The UAV systems 228 can include any type of vehicle control system to control the UAV 204. For example, the UAV systems 228 include a piloting system, a collision warning system, and/or a navigation system, among others. One or more of the UAV systems 228 can be controlled by the inspection application 200 according to the systems and methods discussed herein. The UAV sensors 230 are implemented with the UAV systems 228 and can include various types of sensors for detecting and/or sensing objects on the flight path, in the region of interest, electrical infrastructure (e.g., the electrical infrastructure 108 of FIG. 1), etc. The UAV sensors 230 can include, but are not limited to: a camera, light detection and ranging (LIDAR) sensor, a radio detection and ranging (RADAR) sensor, gyroscopic sensor, proximity sensor, vision sensor, and GPS sensor, among others. The UAV sensors 230 can be any type of sensor, for example, acoustic, electric, environmental, optical, imaging, light, pressure, force, thermal, temperature, and proximity, among others.

A UAV input/output device 232 provides software and hardware to facilitate data input and output between the UAV 204 and the control system 202 via the network 222. For example, sensor data from the UAV sensors 230 may be transmitted to the path predictor 212 via the communication interface 210. In one example, the path predictor 212 generates a predetermined flight path (e.g., the predetermined flight path 106 of FIG. 1) for the UAV 204 to traverse to region of interest for a future inspection. The path predictor 212 determines the predetermined flight path on previous flights of the UAV 204 based on sensor data (e.g., the sensor data 114 of FIG. 1) received from the UAV sensors 230. The path predictor 212 may additionally generate predetermined flight paths to the region of interest based on historical data 234 received from the remote database 220. The historical data 234 include previous flight paths of UAVs, weather data, topographical maps, aeronautical charts, etc.

The region of interest is geographical area that includes an estimated location of a specific component of electrical infrastructure. In some examples, causing the UAV 204 to traverse the flight path includes transmitting the predetermined flight path to the UAV 204. The UAV processor 224 executes the instructions of the predetermined flight path to cause the UAV systems 228 to function to propel the UAV 204 to the region of interest. At the region of interest, the UAV 204 captures initial sensor data (e.g., the initial sensor data 116 of FIG. 1). For example, the initial sensor data include images of the region of interest from the UAV sensors 230. The initial sensor data may include a series of frames and/or a mapping of the region of interest.

The initial sensor data additionally includes location data. For example, the UAV sensors 230 include the position determination unit (not shown) that includes a global positioning system (GPS) unit and/or an inertial measurement unit (IMU). In some examples, the position determination unit provides a geo-position of the UAV 204 and/or objects in the field of view of the UAV sensors 230 based on satellite data from, for example, a global position source, or from any Global Navigational Satellite infrastructure (GNSS), including GPS, Glonass (Russian) and/or Galileo (European). Further, the position determination unit can provide dead-reckoning data or motion data from, for example, a gyroscope, accelerometer, magnetometers, among other UAV sensors 230. In some examples, the position determination unit can be a component of a navigation system of the UAV systems 228.

The identifier 214 identifies the specific component of electrical infrastructure based on the initial sensor data. In some examples, the identifier 214 may use object detection and recognition technology to detect and recognize instance of semantic objects associated with the electrical infrastructure in the initial sensor data. The object detection and recognition technology may be any form data processing such as image processing. Furthermore, the identifier 214 may use machine learning or deep learning to identify the electrical infrastructure 108.

The identifier 214 also determines an actual location of the electrical infrastructure based on the initial sensor data. The actual location is the geo-location of the electrical infrastructure. The actual location may be based on geo-locational coordinates (e.g., global positioning system (GPS) coordinates, differential global positioning system (DGPS) coordinates, street address, mile marker number, directions, etc.). For example, the actual location is based on the location of the UAV 204 when the initial sensor data was acquired. The initial sensor data from the UAV 204 includes location data in the metadata of the initial sensor data. The identifier 214 associates the actual location of the electrical infrastructure based on the location data of the metadata. As another example, the identifier 214 associates an actual location with the initial data based on GPS coordinates of the UAV 204 when the initial sensor data was received by the inspection application 200 in real-time. In yet another example, the identifier 214 uses map data accessed by identifier 214 to determine the actual location based on location data of landmarks (e.g., roads, streets, highways, buildings, geographic feature, etc.). The features of the initial sensor data are compared to the landmarks of the map data to calculate the actual location. The map data may be accessed from the remote database 220.

The identifier 214 also identifies an infrastructure type of the electrical infrastructure based on the initial sensor data. In one example, the identifier 214 uses object detection and recognition technology to identify the infrastructure type for the electrical infrastructure based on the size, shape, energy signature, components, actual location, infrastructure mapping, etc. of the electrical infrastructure. For example, the identifier 214 classifies the electrical infrastructure as a utility pole based on the shape and location of the electrical infrastructure. As another example, the infrastructure type is stored with metadata associated with the identified electrical infrastructure.

The framer 216 identifies a set of desired images (e.g., the set of desired images 118 of FIG. 1) based on the actual location, the electrical infrastructure type, and image parameters that define an image framing of the electrical infrastructure. The set of desired images includes a number of images that constitute an inspection of the electrical infrastructure. For example, the inspection of the electrical infrastructure includes a number of images of components of the electrical infrastructure from different angles. The view of the components and/or electrical infrastructure is based on the image parameters that are intrinsic to UAV sensors 230. The image parameters includes field of view (FOV), focal length, working distance, resolution, depth of field, sensor size, aperture size, and exposure time, among others. Therefore, the framer 216 defines the set of desired images to have a specific framing of the electrical infrastructure based on the actual location, the electrical infrastructure type, and image parameters.

The inspector 218 generates an inspection flight path (e.g., the inspection flight path 120 of FIG. 1) toward the actual location of the electrical infrastructure to capture the set of desired images. The inspector 218 then causes the UAV 204 to obtain a set of captured images (e.g., the captured images 122 of FIG. 1) of the electrical infrastructure corresponding to the set of desired images. Each captured image of the set of captured images having the image framing of the electrical infrastructure. Thus, the inspection application 200 causes UAV 204 to travel a tailored flight path toward the actual location of the electrical infrastructure to capture the set of desired images.

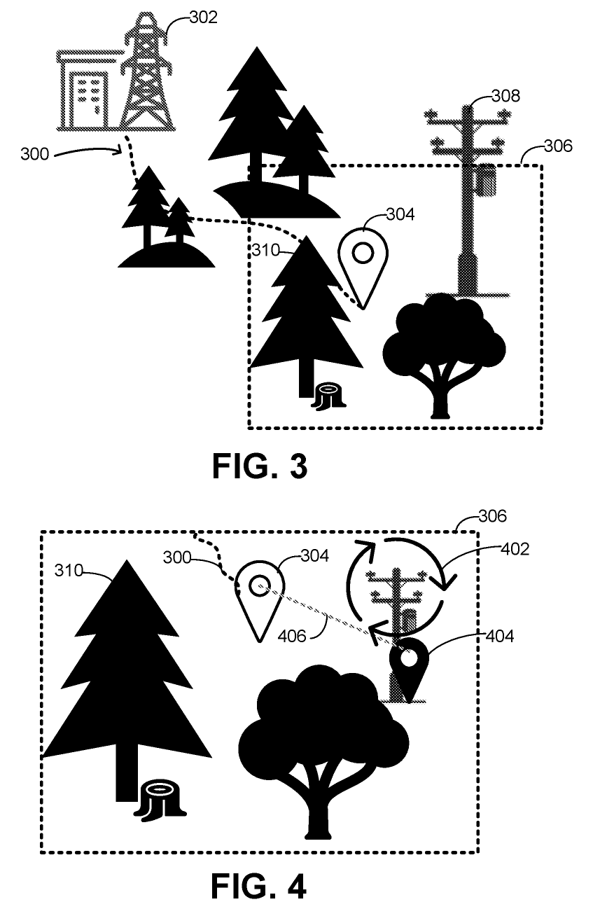

FIG. 3 illustrates a diagram of a predetermined flight path 300 (e.g., the predetermined flight path 106 of FIG. 1) from an origin 302 to an estimated location 304 in a region of interest 306. A UAV (e.g., the UAV 104 of FIG. 1, the UAV 204 of FIG. 2) is deployed from the origin 302, such as an electrical substation, another component of electrical infrastructure in a power distribution system (e.g., the power distribution system 110 of FIG. 1), etc. The predetermined flight path 300 terminates at the estimated location 304 where the electrical infrastructure 308 (e.g., the electrical infrastructure 108 of FIG. 1) is predicted to be.

The region of interest 306 is geographic area around the estimated location 304. The region of interest 306 is defined to allow for error in the prediction of the estimated location 304. The error in the estimated location 304 may be caused by any number of events. For example, the electrical infrastructure 308 may have shifted due to changing topography or been moved to accommodate changes in roadways. As another example, the physical location of the electrical infrastructure may have been adjusted when the electrical infrastructure 308 or components thereof were replaced. Accordingly, a path predictor (e.g., the path predictor 212 of FIG. 2) of an inspection application (e.g., the inspection application 102 of FIG. 1, the inspection application 200 of FIG. 2) predicts the physical location of the electrical infrastructure 308 as the estimated location 304 within a threshold area given as the region of interest 306.

The region of interest 306 can be defined by a threshold distance. For example, the threshold distance may be a radial distance from the estimated location 304, such as one hundred meters in all directions from the estimated location 304. As another example, the threshold distance defining the region of interest 306 may be longitudinal given a layout of the power distribution system (e.g., the power distribution system 110 of FIG. 1). Suppose the power distribution system includes a number of utility poles linked together by overhead powerlines. Then, the region of interest 306 is defined by the course of the overhead powerlines. In one example, the threshold distance is five hundred meters along the course toward the estimated location 304 in the longitudinal direction and five hundred meters along the course away from the estimated location 304 in the longitudinal direction.

The predetermined flight path 300 is a defined route through airspace from the origin 302 to the estimated location 304. In another example, the predetermined flight path includes an iterative path plan that defines the origin 302 and region of interest 306 and flight parameters for determining a route to the region of interest 306 in real-time. For example, the flight parameters include maintaining a designated distance from obstructions 310 (e.g., the obstruction 124 of FIG. 1) or avoiding obstructions 310. The obstruction 310 may be vegetation, infrastructure, buildings, vehicles etc. The flight parameters further include maintaining speed and avoiding biological entities (e.g., humans, birds) among others. In some examples, a path predictor prioritizes the flight parameters. For example, in determining the predetermined flight path 300, the estimated time of arrival at the estimated location 304 is prioritized over a shortest path to the estimated location 304. Thus, as the topography and obstructions change, the predetermined flight path 300 is updated in real-time. Accordingly, the predetermined flight path 300 is a variable route that adjusts for objects in real-time.

Turning to FIG. 4, a diagram including the actual location in the region of interest is shown. For purposes of simplification, FIGS. 3 and 4 employ the same reference numbers to denote the same features. The estimated location 304 of the predetermined flight path 300 is a predicted location of the electrical infrastructure 308. Generating an inspection flight path 402 includes verifying the estimated location 304 is the actual location 404 or calculating an adjusted distance 406 between the estimated location 304 and the actual location 404.

The actual location 404 is the surveyed location of the electrical infrastructure 308 identified by an identifier (e.g., the identifier 214 of FIG. 2) of an inspection application (e.g., the inspection application 102 of FIG. 1, the inspection application 200 of FIG. 2). For example, the actual location 404 is based on the location of the UAV when the initial sensor data was acquired. The identifier utilizes object detection and recognition technology to detect and recognize the electrical infrastructure 308 in the initial sensor data (e.g., the initial sensor data 116 of FIG. 1). The object detection and recognition technology may be any form of data processing such as image processing. Furthermore, the identifier may use machine learning or deep learning to identify the electrical infrastructure 308 and/or the components thereof. For example, the identifier may process the initial sensor data as inputs and utilize a neural network machine learning database to perform object classification, feature recognition, computer vision, machine translation, and the like.

In response to the electrical infrastructure 308 being identified, the actual location 404 of the electrical infrastructure 308 is determined. For example, location data in the metadata of the initial sensor data is associated with the electrical infrastructure 308. The identifier associates the location of the UAV based on the location data of the metadata of the initial sensor data. Alternatively, the identifier associates an actual location 404 with the electrical infrastructure 308 of the initial sensor data based on a position determination unit. In another example, the identifier uses location information from a remote database (e.g., the remote database 220 of FIG. 2) such as mapping data, survey data, or spatial modeling, among others to determine the actual location 404 of the electrical infrastructure 308 relative to the location of the UAV or obstructions imaged in the initial sensor data 116.

The adjusted distance 406 may be measured by an inspector (e.g., the inspector 218 of FIG. 2) of an inspection application based on the initial sensor data 116 captured by the UAV. In some examples, the adjusted distance 406 is defined as the closest distance between the estimated location 304 and the actual location 404. For example, the identifier 214 calculates a closest pair of points problem or other computational geometry to calculate the adjusted distance 406. In another example, the adjusted distance 406 is defined as the navigable distance between the estimated location 304 and the actual location 404. For example, the adjusted distance 406 includes a path around the obstruction 310 rather than through the obstruction 310. When there is no adjusted distance 406 between the estimated location 304 and the actual location 404, the encroachment distance is a null value. For example, the null value may be the result of the actual location 404 being accurately predicted by the estimated location 304. The location data used by the path predictor 212 is updated in response to the adjusted distance 406 being calculated such that a subsequent estimated location of the electrical infrastructure 308 is the actual location 404. Moreover, a subsequent predetermined flight path is calculated based on the actual location 404. Accordingly, the path predictor 212 determines a subsequent predetermined flight path based on the adjusted distance 406 in order to reflect the current status of the electrical infrastructure 308. Thus, the path predictor 212 updates the predetermined flight path 300 for a subsequent inspection.

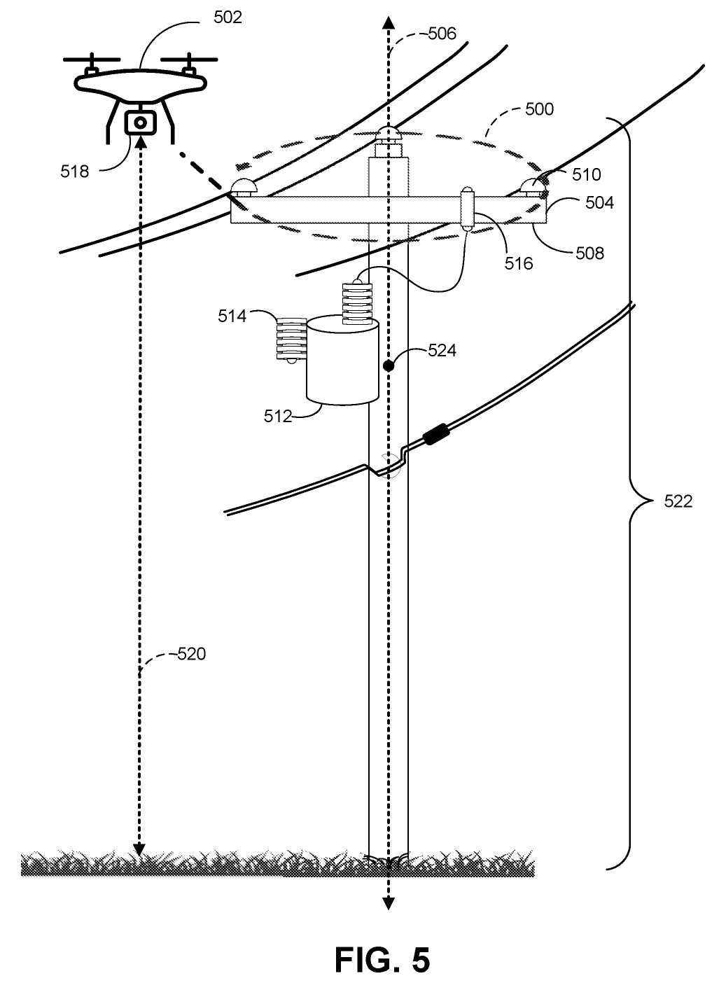

FIG. 5 illustrates a diagram of an inspection flight path 500 of a UAV 502 (e.g., the UAV 104 of FIG. 1, the UAV 204 of FIG. 2) for inspecting electrical infrastructure 504 (e.g., the electrical infrastructure 108 of FIG. 1, the electrical infrastructure 308 of FIGS. 3 and 4. The inspection flight path 500 provides a path toward the actual location (e.g., the actual location 404 of FIG. 4) of the electrical infrastructure 504 to capture the set of desired images (e.g., the set of desired images 118 of FIG. 1). The inspection flight path 500 may also, at least partially, move around the electrical infrastructure 504 to frame the images of the set desired images. For example, the electrical infrastructure 504 has a longitudinal axis 506, and the inspection flight path 500 partially circumnavigates the electrical infrastructure 504 about the longitudinal axis 506.

The set of desired images is based on the electrical infrastructure type. The electrical infrastructure type may be predetermined and recorded in a memory (e.g. the memory 208 of FIG. 2) or as historical data (e.g., the historical data 234 of FIG. 2) accessed by an identifier (e.g., the identifier 214 of FIG. 2) of an inspection application (e.g., the inspection application 102 of FIG. 1, the inspection application 200 of FIG. 2). The electrical infrastructure type is associated with a number of components. As another example, the identifier 214 classifies the electrical infrastructure type of the electrical infrastructure 504 based on images of the components in the initial sensor data (e.g., the initial sensor data 116 of FIG. 1). For example, the identifier 214 includes a neural network trained to identify components of the electrical infrastructure 504. As discussed above, the identifier 214 identifies components from the initial sensor data using a neural network to perform object classification, feature recognition, computer vision, machine translation, and the like. The electrical infrastructure 504 shown in FIG. 5 is a utility pole. The components include a crossbar 508, an insulator 510, a transformer 512, lightning arrestor 514, or fuse 516. Based on sets of components associated with electrical infrastructure types, the neural network determines the electrical infrastructure type based on the identified components.

A set of desired images (e.g., the set of desired images 118 of FIG. 1) define image framing for capturing images of the electrical infrastructure 504 that will satisfy image parameters for an inspection of the electrical infrastructure 504. The framing is a function of the relative positions of a UAV sensor 518 (e.g., the UAV sensors 230 of FIG. 2) of the UAV 502 relative to the electrical infrastructure 504. For example, the UAV sensor 518 be positioned on a planar sweep pedestal (not shown) that allows the UAV sensor to be rotated to capture images of the electrical infrastructure 504 at various angles. As another example, an image parameter defines an in-flight height 520 of the UAV 502. The in-flight height 520 is based on a structure height 522 of the electrical infrastructure 504. The image parameters may additionally define an angle of the UAV 502 relative to the electrical infrastructure 504. As another example, the image parameters position an object center of a plane of the electrical infrastructure 504 at a center point 524 along the longitudinal axis 506. For example, to image the transformer 512, a center point 524 is defined on the longitudinal axis 506 at an object center of the transformer 512 in a plane of the field of view. Thus, the image parameters include yaw, pitch, roll, etc. of the UAV 502 and focal length, zoom, camera angle, etc. of the UAV sensor 518.

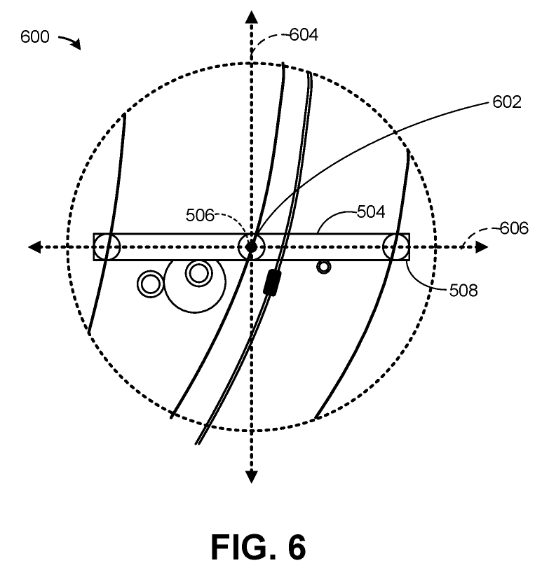

FIG. 6 illustrates an example of image framing based on a field of view 600. For example, the FIG. 6 is a birds-eye-view of the of the electrical infrastructure 504 of FIG. 5. For purposes of simplification, FIGS. 5 and 6 employ the same reference numbers to denote the same features.

The field of view 600 is of a desired image that is axially centered on an axial center 602 of the longitudinal axis 506. In one example, the center point 524 is the axial center 602. The field of view 600 may be divided into quadrants by a first line 604 and a second line 606, orthogonal to the first line 604, that intersect at the axial center 602. In one example, the first line 604 or the second line 606 are aligned with a component of the electrical infrastructure 504, such as the crossbar 508. The image parameters may include pitch angles of the UAV in a quadrant of the quadrants to position an object center of a plane of the electrical infrastructure at a center point.

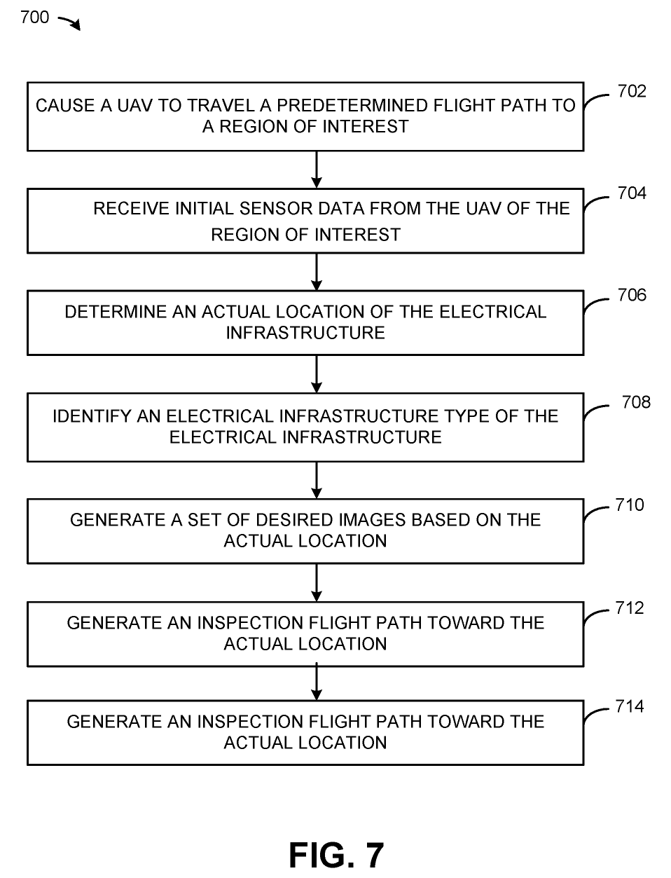

FIG. 7 illustrates a flowchart of an example method 700 for path planning for an unmanned aerial vehicle. FIG. 7 will also be described with reference to FIGS. 1-6. For simplicity, the method 700 will be described as a sequence of blocks, but it is understood that the elements of the method 700 can be organized into different architectures, elements, stages, and/or processes.

At block 702, the method 700 includes causing a UAV (e.g., the UAV 104 of FIG. 1, the UAV 204 of FIG. 2, the UAV 502 of FIG. 5) to travel a predetermined flight path (e.g., the predetermined flight paths 106 of FIG. 1, the predetermined flight path 300 of FIG. 3) to a region of interest (e.g., the region of interest 306 of FIG. 3) including an estimated location (e.g., the estimated location 304 of FIG. 3) of electrical infrastructure (e.g., the electrical infrastructure 108 of FIG. 1, the electrical infrastructure 308 of FIG. 3, the electrical infrastructure 504 of FIG. 5) based on location data of the electrical infrastructure.

At block 704, the method 700 includes the receiving initial sensor data (e.g., the initial sensor data 116 of FIG. 1) from the UAV of the region of interest. The initial sensor data may include an image, a video sequence or a series of images, user inputs, and/or data. In one example, the initial sensor data is captured by UAV systems (e.g., the UAV systems 228 of FIG. 2) and/or UAV sensors (e.g. the UAV sensors 230 of FIG. 2, the UAV sensor 518 of FIG. 5) and transmitted to an inspection application (e.g., the inspection application 102 of FIG. 1, the inspection application 200 of FIG. 2) via a network (e.g., the network 222 of FIG. 2).

At block 706, the method 700 includes determining an actual location (e.g., the actual location 404 of FIG. 4) of the electrical infrastructure based on the initial sensor data. The actual location is the surveyed location of the electrical infrastructure detected by the UAV. For example, the actual location is identified based on the initial sensor data.

At block 708, the method 700 includes identifying an electrical infrastructure type of the electrical infrastructure based on the initial sensor data. For example, identifying the electrical infrastructure type is based on identifying components (e.g., a crossbar 508, an insulator 510, a transformer 512, lightning arrestor 514, or fuse 516 of FIG. 5). In some embodiments, the electrical infrastructure type is a utility pole, and the components of the electrical infrastructure type are predetermined. As one example, determining the electrical infrastructure type of electrical infrastructure includes identifying a longitudinal axis (e.g., the longitudinal axis 506 of FIG. 5) of the electrical infrastructure.

At block 710, the method 700 includes identifying a set of desired images (e.g., the set of desired images 118 of FIG. 1) based on the actual location, the electrical infrastructure type, and image parameters that define an image framing of the electrical infrastructure.

At block 712, the method 700 includes generating an inspection flight path (e.g., the inspection flight path 402 of FIG. 4) toward the actual location of the electrical infrastructure to capture the set of desired images. Generating the inspection flight path includes verifying the estimated location is the actual location or calculating an adjusted distance (e.g., the adjusted distance 406 of FIG. 4) between estimated location and the actual location. The inspection application can cause the UAV to traverse the inspection flight path and capture a number of captured images (e.g., the captured images 122 of FIG. 1).

At block 714, the method 700 includes updating the location data in response to the adjusted distance being calculated. Accordingly, subsequent predetermined flight plans are based on current location data. Furthermore, the predetermined flight plan can be updated in real-time to avoid objects without requiring a human be deployed with the UAV. Accordingly, the captured images depict a current status of the electrical infrastructure and reveal up to date changes in the operation of the electrical infrastructure and its components. Furthermore, because the captured images are at the actual location of the electrical infrastructure, the capture images are framed to capture the components evaluated during an inspection of the electrical infrastructure. Improving the functioning of the inspection application in this manner reduces back-end image processing and mitigates human intervention, thereby saving time and resources that would be otherwise spent correcting the captured images.

What have been described above are examples. It is, of course, not possible to describe every conceivable combination of components or methodologies, but one of ordinary skill in the art will recognize that many further combinations and permutations are possible. Accordingly, the disclosure is intended to embrace all such alterations, modifications, and variations that fall within the scope of this application, including the appended claims. As used herein, the term "includes" means includes but not limited to, the term "including" means including but not limited to. The term "based on" means based at least in part on. Additionally, where the disclosure or claims recite "a," "an," "a first," or "another" element, or the equivalent thereof, it should be interpreted to include one or more than one such element, neither requiring nor excluding two or more such elements.

A “value” as used herein may include, but is not limited to, a numerical or other kind of value or level such as a percentage, a non-numerical value, a discrete state, a discrete value, a continuous value, among others.

In this description, unless otherwise stated, "about," "approximately" or "substantially" preceding a parameter means being within +/- 10 percent of that parameter. Modifications are possible in the described embodiments, and other embodiments are possible, within the scope of the claims.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

It will be appreciated that several of the above-disclosed and other features and functions, or alternatives or varieties thereof, may be desirably combined into many other different systems or applications. Also, that various presently unforeseen or unanticipated alternatives, modifications, variations or improvements therein may be subsequently made by those skilled in the art which are also intended to be encompassed by the following claims.

What is claimed is:

1. A non-transitory machine-readable medium having machine-readable instructions for a flight system causing a processor to execute operations, the operations comprising:
causing an unmanned aerial vehicle (UAV) to travel a predetermined flight path to a region of interest including an estimated location of electrical infrastructure;
receiving initial sensor data from the UAV of the region of interest;
determining an actual location of the electrical infrastructure based on the initial sensor data;
identifying an electrical infrastructure type of the electrical infrastructure based on the initial sensor data;
identifying a set of desired images based on the actual location, the electrical infrastructure type, and image parameters that define an image framing of the electrical infrastructure;
generating an inspection flight path toward the actual location of the electrical infrastructure to capture the set of desired images; and
causing the UAV to obtain a set of captured images of the electrical infrastructure corresponding to the set of desired images, each captured image of the set of captured images having the image framing of the electrical infrastructure.

2. The medium of claim 1, wherein the operations further comprise:
identifying components associated with the electrical infrastructure type, wherein a desired image of the set of desired images corresponds to each of the components.

3. The medium of claim 2, wherein the electrical infrastructure is a utility pole, and the components include one or more of a crossbar, insulator, transformer, switch, lightning arrestor, or fuse.

4. The medium of claim 1, wherein determining the electrical infrastructure type of electrical infrastructure includes identifying a longitudinal axis of the electrical infrastructure, and wherein the image framing is based on a field of view of a desired image of the set of desired images having quadrants and a center point on the longitudinal axis.

5. The medium of claim 4, wherein the image parameters include pitch angles of the UAV in a quadrant of the quadrants to position an object center of a plane of the electrical infrastructure at the center point.

6. The medium of claim 4, wherein the longitudinal axis intersects the center point.

7. The medium of claim 1, wherein the image parameters include an in-flight height of the UAV based on a structure height of the electrical infrastructure.

8. The medium of claim 1, wherein the operations further comprise:
updating the predetermined flight path for a subsequent inspection.

9. The medium of claim 1, wherein the predetermined flight path is based on location data of the electrical infrastructure, wherein generating the inspection flight path includes verifying the estimated location is the actual location or calculating an adjusted distance between the estimated location and the actual location, and wherein the operations further comprise:
updating the location data in response to the adjusted distance being calculated.

10. A flight inspection system comprising:
a memory for storing machine-readable instructions; and
a processor core for accessing the machine-readable instructions and executing the machine-readable instructions as operations, the operations comprising:
causing an unmanned aerial vehicle (UAV) to travel a predetermined flight path to a region of interest including an estimated location of electrical infrastructure;
receiving initial sensor data from the UAV of the region of interest;
determining an actual location of the electrical infrastructure based on the initial sensor data;
identifying an electrical infrastructure type of the electrical infrastructure based on the initial sensor data;
identifying a set of desired images based on the actual location, the electrical infrastructure type, and image parameters that define an image framing of the electrical infrastructure;
generating an inspection flight path toward the actual location of the electrical infrastructure to capture the set of desired images; and
causing the UAV to obtain a set of captured images of the electrical infrastructure corresponding to the set of desired images, captured images of the set of captured images having the image framing of the electrical infrastructure.

11. The flight inspection system of claim 10, wherein the operations further comprise:
identifying components associated with the electrical infrastructure type, wherein a desired image of the set of desired images corresponds to each of the components.

12. The flight inspection system of claim 11, wherein the electrical infrastructure is a utility pole, and the components include one or more of a crossbar, insulator, transformer, switch, lightening arrestor, or fuse.

13. The flight inspection system of claim 10, wherein determining the electrical infrastructure type of electrical infrastructure includes identifying a longitudinal axis of the electrical infrastructure, and wherein the image framing is based on a field of view of a desired image of the set of desired images having quadrants and a center point on the longitudinal axis.

14. The flight inspection system of claim 13, wherein the image parameters include pitch angles of the UAV in a quadrant, of the quadrants, to position an object center of a plane of the electrical infrastructure at the center point.

15. The flight inspection system of claim 13, wherein the longitudinal axis intersects the center point.

16. A path planning method comprising:
causing an unmanned aerial vehicle (UAV) to travel a predetermined flight path to a region of interest including an estimated location of electrical infrastructure based on location data of the electrical infrastructure;
receiving initial sensor data from the UAV of the region of interest;
determining an actual location of the electrical infrastructure based on the initial sensor data;
identifying an electrical infrastructure type of the electrical infrastructure based on the initial sensor data;
generating a set of desired images based on the actual location, the electrical infrastructure type, and image parameters that define an image framing of the electrical infrastructure;
generating an inspection flight path toward the actual location of the electrical infrastructure to capture the set of desired images, wherein generating the inspection flight path includes verifying the estimated location is the actual location or calculating an adjusted distance between the estimated location and the actual location; and
updating the location data in response to the adjusted distance being calculated.

17. The method of claim 16, wherein determining the electrical infrastructure type of electrical infrastructure includes identifying a longitudinal axis of the electrical infrastructure, and wherein the image framing is based on a field of view of a desired image of the set of desired images having quadrants and a center point on the longitudinal axis.

18. The method of claim 17, wherein the image parameters include pitch angles of the UAV in a quadrant, of the quadrants, to position an object center of a plane of the electrical infrastructure at the center point.

19. The method of claim 17, wherein the longitudinal axis intersects the center point.

20. The method of claim 16, wherein the electrical infrastructure includes a plurality of components, and wherein a desired image of the set of desired images includes at least one component of the plurality of components.
